(19) United States
(12) Patent Application Publication
(10) Pub. No.: US 2012/0098844 A1
(43) Pub. Date: Apr. 26, 2012

(54) COMPUTER AND REFRESH RATE ADJUSTMENT METHOD

(75) Inventors: MING-JING SONG, Shenzhen City (CN); YAN LI, Shenzhen City (CN); DE-HUA DANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/171,465

(22) Filed: Jun. 29, 2011

(30) Foreign Application Priority Data
Oct. 20, 2010 (CN) 201010512923.7

(51) Int. Cl. G09G 5/36

(52) U.S. Cl. 345/545

(57) ABSTRACT

A refresh rate adjustment method automatically adjusts a refresh rate of a monitor connected to a computer to a default refresh rate, in response that a detected keystroke signal is a predefined keystroke signal. The method further detects a refresh rate range that is supported by the monitor, detects a new refresh rate input signal from the input device, and determines if the new refresh rate falls within the refresh rate range that is supported by the monitor. If the new refresh rate falls within the refresh rate range that is supported by the monitor, the method automatically adjusts the refresh rate of the monitor with the new refresh rate. Otherwise, the method prompts a user to input the new refresh rate again by displaying a dialog box on the monitor.

### BACKGROUND

1. Technical Field

Embodiments of the present disclosure relate to systems and methods for adjusting display properties of computers, and more particularly, to a computer and a refresh rate adjustment method.

2. Description of Related Art

A refresh rate of a monitor can be adjusted. Generally, increasing the refresh rate decreases flickering, thereby reducing eye strain. However, if the refresh rate is adjusted to be higher than a refresh rate supported by the monitor, the screen of the monitor may go black. In this situation, there are two ways to reset the refresh rate. One way is to connect the computer to a new monitor that can support a higher resolution, logging into an operating system, and adjusting the refresh rate to a lower refresh rate that the prior monitor supports. Another way is to start up the computer in safe mode, which may be achieved by pressing and holding the F8 key when the computer starts to boot up, then adjusting the refresh rate to the lower refresh rate in the safe mode. However, the prior way needs an additional monitor, and the later way requires a common user to be experienced in computer settings.

### BRIEF DESCRIPTION OF THE DRAWINGS

FIG. 1 is a block diagram of one embodiment of function modules of a computer including a refresh rate adjustment system.

FIG. 2 is a block diagram of one embodiment of function modules of the refresh rate adjustment system in FIG. 1.

FIG. 3 is a block diagram of one embodiment of a refresh rate adjustment method.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

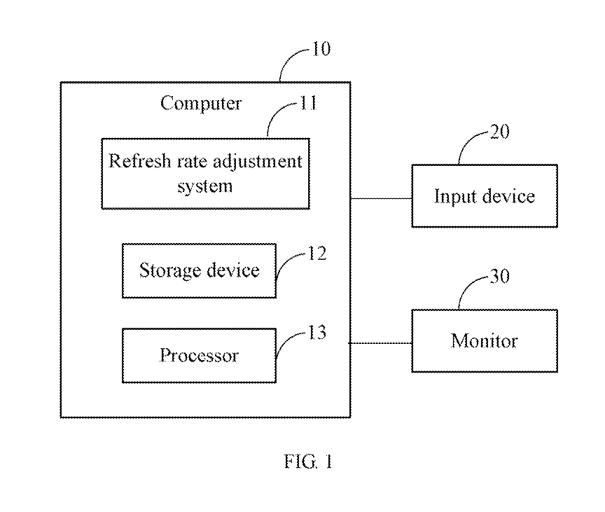

FIG. 1 is a block diagram of one embodiment of function modules of a computer 10 including a refresh rate adjustment system 11. In one embodiment, the computer 10 connects with an input device 20 and a monitor 30. The refresh rate adjustment system 11 adjusts a refresh rate of the monitor 30 to a refresh rate supported by the monitor 30 according to input from the input device 20. The input device 20 may be a keyboard or a touch panel. The monitor 30 may be a cathode-ray tube (CRT) screen or a liquid crystal display (LCD). The computer 10 further includes a storage device 12 and a processor 13.

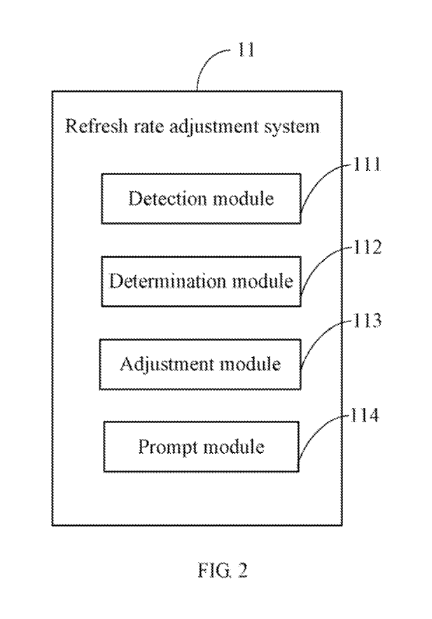

As shown in FIG. 2, the refresh rate adjustment system 11 includes a detection module 111, a determination module 112, an adjustment module 113, and a prompt module 114. The modules 111-114 may comprise computerized code in the form of one or more programs that are stored in the storage device 12. The computerized code includes instructions that are executed by the processor 13 to provide the below described functions of the modules 111-114.

The detection module 111 is operable to detect a keystroke signal from the input device 20 after the computer 10 is started up.

The determination module 112 is operable to determine that if the detected keystroke signal is a predefined keystroke signal. For example, the predefined keystroke signal may be generated from pressing a predefined key combination, such as #SXL#, or be generated from a predefined hotkey.

The adjustment module 113 is operable to automatically adjust the refresh rate of the monitor 30 to a default refresh rate that are supported by most types of monitors, such as 60 Hz, so that the monitor 30 can display data, in response that the detected keystroke signal is the predefined keystroke signal.

The prompt module 114 is operable to display a dialog box on the monitor 30, to prompt if a user of the computer 10 would like to adjust the refresh rate of the monitor 30. An example is given in FIG. 4.

The detection module 111 is further operable to detect a refresh rate range supported by the monitor 30, and detect a new refresh rate input signal from the input device 20. For example, the refresh rate range supported by the monitor 30 may be 60 Hz-75 Hz.

The determination module 112 is further operable to determine if the new refresh rate falls within the refresh rate range that is supported by the monitor 30.

The adjustment module 113 is further operable to automatically adjust the refresh rate of the monitor 30 to the new refresh rate, in response that the new refresh rate falls within the refresh rate range that is supported by the monitor 30. For example, if the new refresh rate is 70 Hz, which falls within the refresh rate range 60 Hz-75 Hz of the monitor 30, the adjustment module 113 automatically replaces the default refresh rate 60 Hz with the new refresh rate 70 Hz.

The prompt module 114 is further operable to prompt if the new refresh rate is invalid and prompt the user to input the new refresh rate again, in response that the new refresh rate falls out of the refresh rate range that is supported by the monitor 30. For example, if the new refresh rate is 80 Hz, which falls out of the refresh rate range 60 Hz-75 Hz of the monitor 30, the prompt module 114 prompts that 80 Hz is invalid.

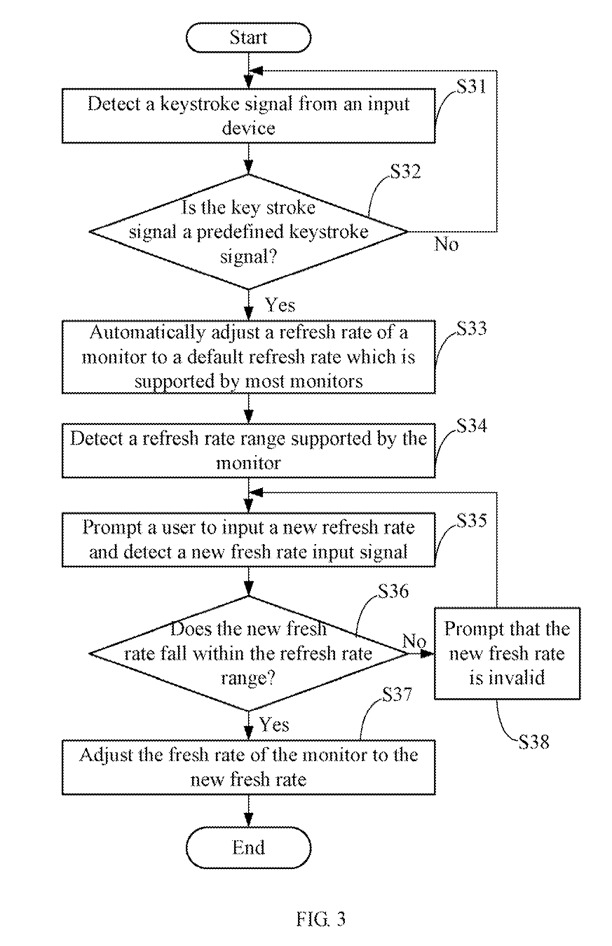

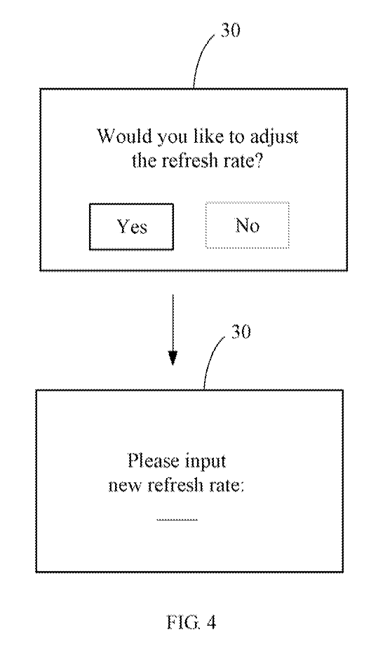

FIG. 3 is a flowchart of one embodiment of a refresh rate adjustment method. Depending on the embodiment, additional blocks may be added, others removed, and the ordering of the blocks may be changed.

In block S31, the detection module 111 detects a keystroke signal from the input device 20 after the computer 10 is started up.

In block S32, the determination module 112 determines if the detected keystroke signal is a predefined keystroke signal. As mentioned above, the predefined keystroke signal may be generated from pressing a predefined key combination, such as #SXL#. If the detected keystroke signal is not the predefined keystroke signal, the procedure returns to block S31. Otherwise, if the detected keystroke signal is the predefined keystroke signal, block S33 is implemented.

In block S33, the adjustment module 113 automatically adjusts the refresh rate of the monitor 30 to a default refresh rate that are supported by most types of monitors, such as 60 Hz, so that the monitor 30 can display data.

In block S34, the detection module 111 detects a refresh rate range supported by the monitor 30. For example, the refresh rate range that is supported by the monitor 30 may be 60 Hz-75 Hz.

In block S35, the prompt module 114 prompts a user to input a new refresh rate by displaying dialog boxes on the monitor 30. For example, as shown in FIG. 4, the prompt module 114 displays a dialog box “Would you like to adjust the refresh rate?” If the user clicks “Yes,” then the prompt module 114 further displays a dialog box “Please input new refresh rate:” to receive data input by the user. Then, the detection module 111 detects a new refresh rate input signal from the input device 20.

In block 36, the determination module 112 determines if the new refresh rate falls within the refresh rate range that is supported by the monitor 30. If the new refresh rate falls out of the refresh rate range that is supported by the monitor 30, such as if the new refresh rate is 80 Hz, block S38 is implemented, the prompt module 114 prompts that the new refresh rate is invalid. Then, the procedure goes to block S35. Otherwise, if the new refresh rate falls within the refresh rate range that is supported by the monitor 30, such as if the new refresh rate is 70 Hz, block S37 is implemented.

In block 37, the adjustment module 113 automatically adjusts the refresh rate of the monitor 30 to the new refresh rate. For example, the adjustment module 113 automatically replaces the default refresh rate 60 Hz with the new refresh rate 70 Hz.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A refresh rate adjustment method of a monitor connected to a computer, comprising:
detecting a keystroke signal from an input device connected to the computer;
determining if the detected keystroke signal is a predefined keystroke signal;
automatically adjusting a refresh rate of the monitor to a default refresh rate, in response that the detected keystroke signal is the predefined keystroke signal;
detecting a refresh rate range that is supported by the monitor, and detecting a new refresh rate input signal from the input device;
determining if the new refresh rate falls within the refresh rate range that is supported by the monitor; and
adjusting the refresh rate of the monitor to the new refresh rate, in response that the new refresh rate falls within the refresh rate range that is supported by the monitor.

2. The method of claim 1, before detecting the new refresh rate input signal from the input device further comprising:
prompting a user to input a new refresh rate by displaying a dialog box on the monitor.

3. The method of claim 2, further comprising:
prompting that the new refresh rate is invalid, in response that the new refresh rate falls out of the refresh rate range that is supported by the monitor; and
returning to the block of detecting the new refresh rate input signal from the input device.

4. The method of claim 1, wherein the predefined keystroke signal is generated from pressing a predefined key combination or a predefined hotkey.

5. A computer, comprising:
a storage device;
a processor; and
one or more programs stored in the storage device and executable by the processor, the one or more programs comprising:
a detection module operable to detect a keystroke signal from an input device connected to a computer after the computer is started up;
a determination module operable to determine if the detected keystroke signal is a predefined keystroke signal;
an adjustment module operable to automatically adjust a refresh rate of a monitor connected to the computer to a default refresh rate, in response that the detected keystroke signal is the predefined keystroke signal;
the detection module further operable to detect a refresh rate range that is supported by the monitor, and detect a new refresh rate input signal from the input device;
the determination module further operable to determine if the new refresh rate falls within the refresh rate range that is supported by the monitor; and
the adjustment module further operable to adjust the refresh rate of the monitor to the new refresh rate, in response that the new refresh rate falls within the refresh rate range that is supported by the monitor.

6. The computer of claim 5, wherein one or more programs further comprise:
a prompt module operable to prompt a user to input a new refresh rate by displaying a dialog box on the monitor, before detecting the new refresh rate input signal from the input device.

7. The computer of claim 6, wherein the prompt module is further operable to prompt that the new refresh rate is invalid, in response that the new refresh rate falls out of the refresh rate range that is supported by the monitor.

8. The computer of claim 5, wherein the predefined keystroke signal is generated from pressing a predefined key combination or a predefined hotkey.

9. A non-transitory computer readable medium storing a set of instructions, the set of instructions capable of being executed by processors to perform a refresh rate adjustment method of a monitor connected to a computer, the method comprising:
detecting a keystroke signal from an input device connected to the computer after the computer is started up;
determining if the detected keystroke signal is a predefined keystroke signal;
automatically adjusting a refresh rate of the monitor to a default refresh rate, in response that the detected keystroke signal is the predefined keystroke signal;
detecting a refresh rate range that is supported by the monitor, and detecting a new refresh rate input signal from the input device;
determining if the new refresh rate falls within the refresh rate range that is supported by the monitor; and
adjust the refresh rate of the monitor to the new refresh rate, in response that the new refresh rate falls within the refresh rate range that is supported by the monitor.

10. The non-transitory computer readable medium of claim 9, wherein before detecting the new refresh rate input signal from the input device further comprises:
prompting a user to input a new refresh rate by displaying a dialog box on the monitor.

11. The non-transitory computer readable medium of claim 10, wherein the method further comprises:
prompting that the new refresh rate is invalid, in response that the new refresh rate falls out of the refresh rate range that is supported by the monitor; and
returning to the block of detecting the new refresh rate from the input device.

12. The non-transitory computer readable medium of claim 9, wherein the predefined keystroke signal is generated from pressing a predefined key combination or a predefined hotkey.
